(19) United States
(12) Patent Application Publication
(10) Pub. No.: US 2005/0107165 A1
(43) Pub. Date: May 19, 2005

(54) Hand-held game machine

(76) Inventors: Geoffrey S. Mendelson, Jerusalem (IL); Paul H. Mendelson, Jerusalem (IL)

Correspondence Address: DANIEL J SWIRSKY, PO BOX 2345, BEIT SHEMESH, 99544, IL

(21) Appl. No.: 10/706,032

(22) Filed: Nov. 13, 2003

(51) Int. Cl. A63F 13/00; A63F 9/24; H04N 7/16; H04N 7/173; A63F 9/14; G06F 19/00; G06F 17/00

(52) U.S. Cl. 463/46; 463/41; 463/42; 463/6; 463/36

(57) ABSTRACT

A method for running a computer game includes the step of running the game on a hand-held game machine for which it is not designed without having to rewrite the game. This involves interfacing between the computer and the input/output and operational expectations of a current game. In one embodiment, the interfacing is performed with a compatibility layer having at least an input mapper to convert between input keys of the game machine and the input expectations of the current game.

### FIELD OF THE INVENTION

The present invention relates to game machines generally and to hand-held game machines in particular.

### BACKGROUND OF THE INVENTION

Computer games have been around for many years and are very popular. They can be played on many different types of computers, such as standard personal computers (PCs) and specialized game machines. Two well-known game machines, which are both hand-held, are the Gameboy, commercially available from Nintendo Co., Ltd., of Kyoto, Japan, and the N-Gage, commercially available from Nokia Corporation of Finland.

Unfortunately, a game designed for the N-Gage is not playable on the Gameboy and vice versa, nor is a game designed for a personal computer playable on a specialized game machine.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a game machine, constructed and operative in accordance with the present invention, and its environment;

FIGS. 2A and 2B are schematic illustrations of the game machine of FIG. 1 playing two different games;

FIG. 3 is a block diagram illustration of elements of the game machine of FIG. 1; and

FIG. 4 is a block diagram illustration of an input mapper forming part of the game machine of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention maybe practiced without these specific details. In other instances, well-known methods, procedures, and components have not been described in detail so as not to obscure the present invention.

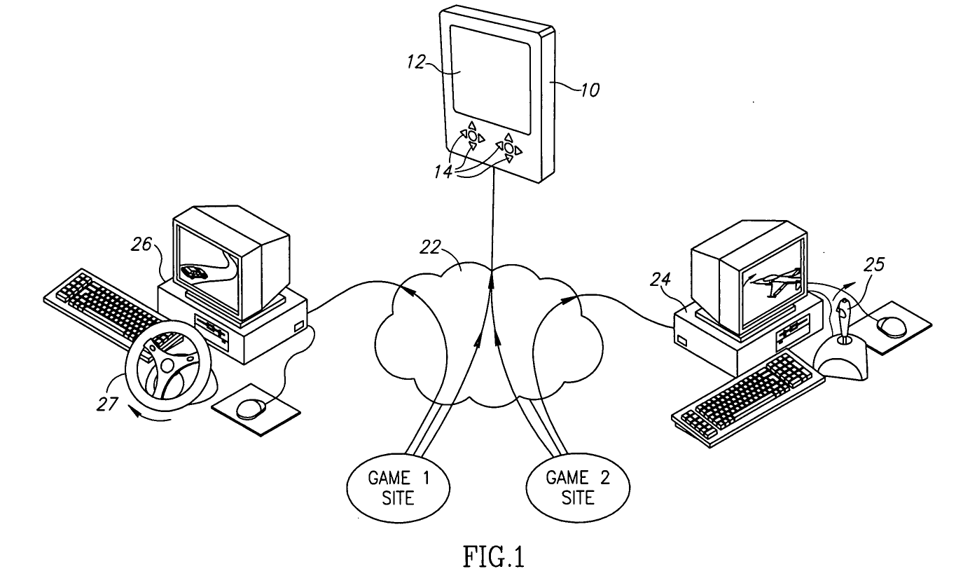

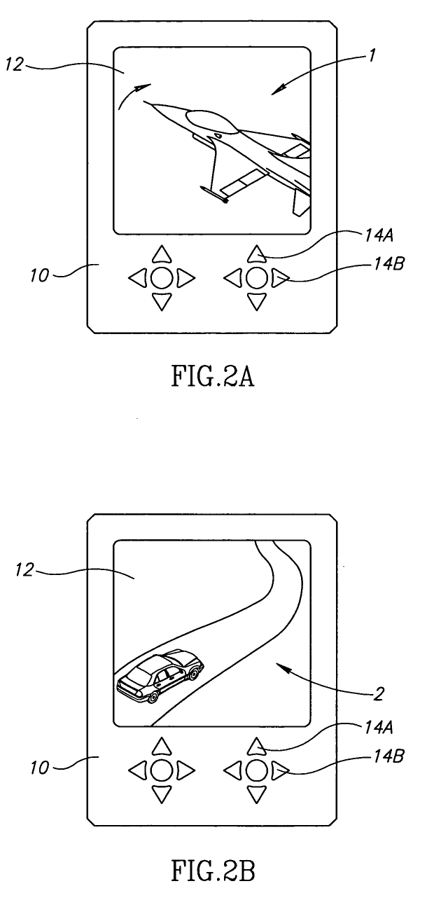

Reference is now made to FIG. 1, which illustrates a game machine 10, constructed and operative in accordance with the present invention, connected to a network and to FIGS. 2A and 2B which are exemplary illustrations of the operation of game machine 10.

Game machine 10 may be a hand-held game machine and may comprise a screen 12 and one or more sets of buttons 14. In one embodiment of the present invention, game machine 10 may be a computer, with buttons 14 as its input, screen 12 as its output, a central processing unit (CPU) such as an Intel compatible processor, and other hardware, such as a modem or network device, for connecting to a network. Other hardware may include storage units of various kinds, input/output units and communication devices. The computer may also include an operating system, such as the public domain Linux operating system, to operate the various hardware elements and to interface to any applications running thereon. However, this is an example only; other architectures for game machine 10 are incorporated in the present invention.

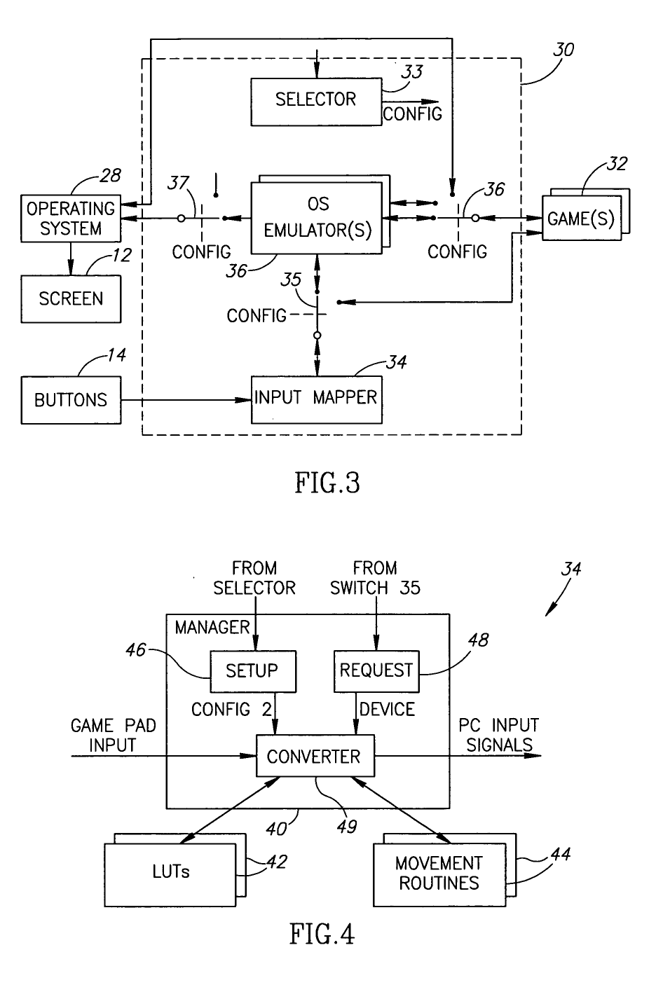

In accordance with a preferred embodiment of the present invention, game machine 10 may also include means (shown in FIG. 3) that enable it to play a game designed to play on another type of machine, such as on a personal computer or on another type of game machine, without the need to “port” the game to the specific hardware of game machine 10 or to have the specific input devices for which the game was originally designed.

In one embodiment, shown in FIG. 1, game machine 10 may be connectable to the Internet 22 and may be capable of downloading games from websites thereon. For example, FIG. 1 shows game machine 10 downloading a game 1 from a game site 1. Game 1 may be a flight simulator, designed for playing on a personal computer 24 with a joystick 25. Game machine 10 may also download a road race game 2 from a game site 2, where road race game 2 may also be designed for playing on a personal computer 26, however using a steering wheel 27.

In accordance with a preferred embodiment of the present invention, game machine 10 may run either of games 1 or 2, as selected by a user, without the user having to reconfigure game machine 10 to do so. In FIG. 2A, game machine 10 may be running game 1 and game machine 10 may have “right up” button 14A and “right right” button 14B configured together to implement the clockwise yaw rotation of joystick 25 (FIG. 1). In FIG. 2B, game machine 10 may be running game 2 and game machine 10 may have right up button 14A configured to implement “moving straight”, while right right button 14B might be configured to implement the clockwise movement of steering wheel 27 of FIG. 1. Thus, how a button may behave may depend on the game being played.

It will be appreciated that, in the present invention, the configuration of buttons 14 may be flexible and may be a function of the type of input device for which the game currently being played was originally designed. Exemplary types of input devices might be keyboards, computer mice, joysticks, game pads, drawing pads, foot pedals, steering wheels and others.

Reference is now made to FIG. 3, which illustrates the elements of game machine 10 in block diagram form. In addition to screen 12 and buttons 14, described hereinabove, game machine 10 may also comprise a native operating system 28, such as the Linux operating system, which may interface between the hardware elements of game machine 10 and any applications running thereon. In accordance with a preferred embodiment of the present invention, game machine 10 may also comprise a compatibility layer 30, which may interface between the input/output and operational expectations of the games, here labeled 32, and the input/output abilities and hardware (and/or native operating system 28) of game machine 10.

Compatibility layer 30 may comprise a selector 33, an input mapper 34 and one or more operating system (OS) emulators 36. Input mapper 34 may map the output of buttons 14 to the type of input current game 32 may expect. As described hereinabove, the output may vary according to the type(s) of input device(s) for which game 32 may be designed.

Each OS emulator 36 may emulate a common operating system and for which many computer games have been written. For example, the Windows Operating System, commercially available in many versions from Microsoft Corporation of the USA, is very common and there are many games written to operate thereon. The public domain WINE emulator, may emulate the various Windows operating systems and may run on top of Linux operating on an Intel or Intel compatible processor. Another common operating system is the DOS OS, also commercially available from Microsoft. The public domain DOSEMU emulator may emulate the DOS operating system for Linux machines. Other suitable public domain emulators include MAME, which emulates many video game machines and consoles, BasiliskII, which emulates Apple Macintosh computers with 680x0 processors, Virtual GameBoy, which emulates Nintendo GameBoy and GameBoy Advance game machines, MESS, which emulates many handheld games, old computers and consoles, and Hercules, which emulates IBM mainframe computers.

Compatibility layer 30 may have multiple OS emulators, in order to run games designed for many types of machines and operating systems. The type of OS emulators 36 may depend on the type of architecture of game machine 10, on the particular operating system implemented thereon as well as the types of operating systems for which the games to be played were originally designed.

Selector 33 may receive information from a user as to the type of game 32 to be played. This information may include the type of operating system and the type of input devices for which current game 32 was originally designed. Selector 33 may then select the appropriate operating system to be active with current game 32 (either native operating system 28 or one of OS emulators 36) and may instruct input mapper 34 as to the type of input device to emulate.

For clarity, FIG. 3 shows the output of selector 33 as a CONFIG signal controlling the operation of switches 35, 36 and 37. If the original operating system for current game 32 was other than native operating system 28, switch 35 may direct the output of input mapper to the selected OS emulator 36, switch 36 may direct the output of current game 32 to the selected OS emulator 36 and switch 37 may direct the output of the selected OS emulator 36 to native operating system 28.

If the original operating system for current game 32 was native operating system 28, then switch 35 may direct the output of input mapper to current game 32. Switch 36 may direct the output of current game 32 to native operating system 28 and switch 37 may disconnect the OS emulators 36.

When running current game 32, the user may press on one or more buttons 14. Input mapper 34 may convert the button movement to the appropriate input signals for game 32 and provide the input signals to game 32. In turn, game 32 may respond to the input signals, providing screen output and, possibly, other operational signals to the appropriate OS emulator 36 which, in turn, may provide the screen output and operational signals to native operating system 28. Operating system 28 may then perform the requested operation(s), one of which may be to provide output to screen 12. If native operating system 28 is the currently active operating system, then game 32 may work directly with native operating system 28.

Game 32 may request system services. For games designed for operating systems other than native operating system 28, the selected OS emulator 36 may respond to these requests, acting for game 32 as though it were the operating system. Exemplary system services might be displaying something on screen 12, making a sound, giving memory, placing data on the system stack, opening or closing a file, providing an input event, etc. In accordance with a preferred embodiment of the present invention, the latter (an input event) may be received from input mapper 34.

Reference is now made to FIG. 4, which illustrates an exemplary embodiment of input mapper 34. In this embodiment, mapper 34 may comprise a manager 40, a plurality of device lookup tables (LUTs) 42 and a multiplicity of movement routines 44. Manager 40 may comprise a setup section 46, a request section 48 and a converter 49.

In setup program 46, selector 33 may indicate the type of input devices for which current game 32 may have been designed. The setup program may provide a configuration signal CONFIG2 to converter 49 indicating the type of input devices, Alternatively or in addition, some games, such as those operating under the Windows operating system, may issue requests and the requests may indicate the type of input to be provided. Switch 35 may pass such requests to input mapper 34 and request section 48 may determine the type of input being requested and may issue the appropriate indication, labeled DEVICE, to converter 49.

With the configuration signal CONFIG2 and/or the device signal DEVICE, converter 49 may select the relevant lookup table 42 associated with the relevant type of input device to be active. When one of buttons 14 may be pressed, manager 40 may refer to the active lookup table 42 to determine which input signals to provide to current game 32. Some input signals have simple conversions, such as “right right button=right click”. Most of the input signals are more complicated and are intended to generate device motion. The latter require motion routines to simulate the input signal. For this type of signal, converter 49 may activate the appropriate movement routine 44 to generate the appropriate signal. Converter 49 may then provide the generated signal as output. For example, pressing on one of buttons 14 may require converter 49 to generate clockwise rotation at a given speed, such as 10° per sec. Another button press might require converter 49 to generate mouse motion to the right. Still another might generate joystick up motion at a speed of 0.1° per sec.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A hand-held game machine capable of playing games designed to run on other machines.

2. A machine according to claim 1 and comprising:
a computer having hardware, an operating system, input keys and an output unit;
a game storage unit to store said games; and
a compatibility layer to interface between said computer and the input/output and operational expectations of a current game.

3. A machine according to claim 2 and wherein said compatibility layer comprises an input mapper and at least one operating system emulator.

4. A machine according to claim 3 and wherein said input mapper comprises a converter to convert between said input keys and said input expectations of said current game.

5. A machine according to claim 4 and wherein said input mapper comprises conversion units, one per type of input device.

6. A machine according to claim 4 and wherein said input mapper comprises a request unit to determine a type of input device from an input request from said current game.

7. A machine according to claim 6 and wherein said input mapper selects the type of input device to emulate from the output of said request unit.

8. A compatibility layer for a game machine to enable said game machine to run games written for other machines.

9. A layer according to claim 8 and wherein said compatibility layer comprises an input mapper.

10. A layer according to claim 9 and wherein said input mapper comprises a converter to convert between input keys of said game machine and input expectations of a current game.

11. A layer according to claim 10 and wherein said input mapper comprises conversion units, one per type of input device.

12. A layer according to claim 10 and wherein said input mapper comprises a request unit to determine a type of input device from an input request from said current game.

13. A layer according to claim 12 and wherein said input mapper selects the type of input device to emulate from the output of said request unit.

14. A method for running a computer game, the method comprising:
running said game on a hand-held game machine for which it is not designed without having to rewrite said game.

15. A method according to claim 14 and wherein said running comprises converting between input keys of said game machine and input expectations of said game.

16. A method according to claim 15 and wherein said converting comprises utilizing conversion units, one per type of input device.

17. A method according to claim 15 and wherein said converting comprises determining a type of input device from an input request from said game.

18. A method according to claim 17 and wherein said converting comprises selecting the type of input device to emulate from the output of said request unit.

19. A method for running a computer game, the method comprising:
receiving on a current machine a downloaded computer game designed for a different machine than said current machine;
indicating the input devices expected by said computer game;
configuring the input devices of said current machine to act like said expected input devices; and
running said computer game with said current input devices.

20. A method according to claim 19 and wherein said running comprises converting between input devices of said game machine and input expectations of said game.

21. A method according to claim 20 and wherein said converting comprises utilizing conversion units, one per type of input device.
